(19) United States
(12) Patent Application Publication
(10) Pub. No.: US 2009/0205172 A1
(43) Pub. Date: Aug. 20, 2009

(54) Cable termination with an elliptical wall profile

(76) Inventors: Richard V. Campbell, Tallahassee, FL (US); David Sediles, Tallahassee, FL (US)

Correspondence Address: John Wiley Horton;Pennington, Moore, Wilkinson, Bell & Dunbar P.A., 215 S. Monroe St., 2nd Floor, Tallahassee, FL, 32301, US

(21) Appl. No.: 12/070,439

(22) Filed: Feb. 19, 2008

(51) Int. Cl. F16G 11/00

(52) U.S. Cl. 24/129 R

(57) ABSTRACT

An anchor having an internal passage defined by a revolved wall profile. The anchor is conceptually divided into four regions: a neck region, a transition region, a mid region, and a distal region. Each of these regions has its own design considerations. A portion of an ellipse is used to define at least part of the revolved wall profile. The use of an elliptical portion allows the anchor to be optimized for the different regions.

### MICROFICHE APPENDIX

Not Applicable

### BACKGROUND OF THE INVENTION

1. Field of the Invention

This invention relates to the field of cables and cable terminations. More specifically, the invention comprises a cable termination including an elliptical wall profile.

2. Description of the Related Art

There are many known devices for mounting a termination on the end of a wire, rope, or cable. The individual components of a wire rope are generally referred to as “strands,” whereas the individual components of natural-fiber cables or synthetic cables are generally referred to as “fibers.” For purposes of this application, the term “strands” will be used generically to refer to both.

In order to carry a tensile load an appropriate connective device must be added to a cable. A connective device is typically added to an end of the cable, but may also be added at some intermediate point between the two ends. FIG. 1 shows a connective device which is well known in the art. An anchor 18 has been attached to the free end of a cable 10 to form a termination 14.

FIG. 2 shows the same assembly sectioned in half to show its internal details. Anchor 18 includes internal passage 28 running through its mid portion. In order to affix anchor 18 to cable 10, the strands proximate the end of cable 10 are exposed and placed within internal passage 28 (They may also be splayed or fanned to conform to the expanding shape of the passage).

Liquid potting compound is added to the region of strands lying within the anchor (either before or after the strands are placed within the anchor). This liquid potting compound solidifies while the strands are within the anchor to form potted region 16 as shown in FIG. 2. Most of potted region 16 consists of a composite structure of strands and solidified potting compound. Potting transition 20 is the boundary between the length of strands which is locked within the solidified potting compound and the freely-flexing length within the rest of the cable (flexible region 30).

The unified assembly shown in FIGS. 1 and 2 is referred to as a “termination” (designated as “14” in the view). The mechanical fitting itself is referred to as an “anchor” (designated as “18” in the view). Thus, an anchor is affixed to a cable to form a termination. These terms will be used consistently throughout this disclosure.

Cables such as the one shown in FIG. 2 are used to carry tensile loads. When a tensile load is placed on the cable, this load must be transmitted to the anchor, and then from the anchor to whatever component the cable attaches to (typically through a thread, flange, or other fastening feature found on the anchor). As an example, if the cable is used in a winch, the anchor might include a large hook.

Those skilled in the art will realize that potted region 16 is locked within anchor 18 by a mechanical interference resulting from the geometry of internal passage 28. FIG. 3 is a sectional view showing the potted region removed from the anchor. As shown in FIG. 3, internal passage 28 molds the shape of potted region 16 so that a mechanical interference is created between the two conical surfaces. When the potted region first solidifies, a surface bond is often created between the potted region and the wall of the tapered cavity. When the cable is initially loaded, the potted region is pulled downward (with respect to the orientation shown in the view) within the tapered cavity. This action is often referred to as “seating” the potted region. The surface bond typically fractures. Potted region 16 is then retained within tapered cavity 28 solely by the mechanical interference of the mating male and female conical surfaces.

FIG. 4 shows the assembly of FIG. 3 in a sectioned elevation view. The geometry is all revolved around central axis 51, which runs through the anchor from neck anchor boundary 48 to distal anchor boundary 50. One can define the slope of the wall profile at any point along the internal passage with respect to this central axis. For purposes of this disclosure, a positive slope for the wall profile will mean a slope in which the distance from the central axis to the wall is increasing as one proceeds from the proximal anchor boundary to the distal anchor boundary.

As mentioned previously, the seating process places considerable shearing stress on the surface bond between the potted region and the wall, which often breaks. Further downward movement is arrested by the compressive forces exerted on the potted region by the shape of the internal passage (Spatial terms such as “downward”, “upper”, and “mid” are used throughout this disclosure. These terms are to be understood with respect to the orientations shown in the views. The assemblies shown can be used in any orientation. Thus, if a cable assembly is used in an inverted position, what was described as the “upper region” herein may be the lowest portion of the assembly).

The compressive stress on potted region 16 tends to be maximized in neck region 22. Flexural stresses tend to be maximized in this region as well, since it is the transition between the freely flexing and rigidly locked regions of the strands. The tensile stresses within potted region 16 likewise tend to be maximized in neck region 22, since it represents the minimum cross-sectional area. Thus, it is typical for terminations such as shown in FIGS. 1-4 to fail within neck region 22.

In FIG. 4, potted region 16 is conceptually divided into neck region 22, mid region 24, and distal region 26. Potting transition 20 denotes the interface between the relatively rigid potted region 16 and the relatively freely flexing flexible region 30. Stress is generally highest in neck region 22, lower in mid region 24, and lowest in distal region 26.

The prior art anchor shown in FIGS. 1-4 uses a revolved linear wall profile (a conical shape for the internal passage). While this profile is commonly used, it is far from optimum. The design considerations present in the neck region, mid region, and distal region are quite different. FIG. 5 illustrates—in very general terms—the nature of these design considerations. In neck region 22, the wall profile is preferably tangent or nearly tangent to the cable's outside diameter. Thus, tangent wall 32 is ideal for neck region 22.

The solidified potted region expands as one proceeds from the anchor's neck region toward the distal region. A relatively rapid expansion can be used to form a “shoulder” in the wall profile. FIG. 5 shows a shoulder 34 formed by a relatively steeply sloping wall profile in mid region 24. This forms a solid mechanical interference which will hold the potted mass in place. The potted mass lying between the shoulder and the neck region is preferably allowed to elongate (“seat”) somewhat under tension, thereby forming a more even stress distribution. Thus, the inclusion of a shoulder is preferable for the mid region.

Of course, if one continues the steeply sloping wall profile of the shoulder toward the anchor's distal end, the anchor will have to be made very large to contain the profile. The stress tends to diminish as one approaches the distal region. Thus, there is little to be gained by continuing the steeply sloping profile of the shoulder. At some point it is preferable to discontinue the sloping wall profile and employ a profile having a more moderate slope. FIG. 5 shows the use of such a portion, which is designated as extension wall 36.

The reader will thereby perceive the differing and somewhat contradictory design goals present in the anchor's neck, mid, and distal regions. Several prior art anchors have attempted to reconcile these conflicting goals. FIG. 6 is a sectioned elevation view of one such prior art anchor. The wall profile is a revolved constant radius arc 38 (revolved around central axis 51). Arc center 40 is positioned so that tangency point 74 is created with the cable at the point where the cable exits the anchor. Thus, the goal of creating tangency with the cable is met.

The goal of creating a shoulder in the mid region can also be met using a constant radius arc. The reader will observe in the example illustrated that the wall profile has a fairly steep slope in the mid region, thereby forming a suitable shoulder 34. The problem with the use of the constant radius arc in this fashion is the slope existing between tangency point 74 and the shoulder. The wall's slope increases fairly rapidly as one proceeds from tangency point 74 toward the distal anchor boundary. A more gradually increasing slope is preferable, since this would allow the potted mass in the vicinity of the neck to elongate somewhat under tension. This elongation produces a more even stress distribution. However, the rapidly increasing slope inherent in the constant radius arc design prevents the solidified potted region in the vicinity of the neck from elongating without experiencing excessive compressive stress. Thus, the use of the constant radius arc tends to concentrate stress in the neck region. The result is an anchor which fails significantly below the ultimate tensile strength of the cable itself.

FIG. 7 shows another prior art geometry which attempts to address the problem of stress concentration in the neck region. In the anchor illustrated in FIG. 7, the revolved wall is defined by a portion of a parabola 42. The parabola's focus 44 is positioned appropriately—and the constants governing the parabola are appropriately selected—to produce a wall profile such as shown. Parabolic wall 45 includes a shoulder 34 in the mid region. It also includes a slope in the neck region which is not rapidly changing (and therefore produces a reasonably even stress distribution in the neck region). However, the reader will observe the presence of non-tangent condition 46 at the neck anchor boundary. This non-tangent condition produces a significant stress concentration at the point where the cable exits the neck anchor boundary. The stress concentration is further amplified in the event the freely flexing portion of the cable is flexed laterally with respect to the anchor.

Those skilled in the art will readily appreciate that one way to create a tangent condition at the neck anchor boundary using a parabola is to make the outside diameter of the cable an asymptote of the parabola. Unfortunately, making the outside diameter of the cable an asymptote will mean that the parabolic wall profile will have insufficient slope to form the necessary mechanical interference. This explains why anchors using parabolic wall profiles have been forced to use a non-tangent condition at the neck anchor boundary. The result is an undesirable stress concentration in the neck region. Like the version using the constant radius arc, the termination of FIG. 7 tends to fail well short of the cable's ultimate tensile strength.

An ideal wall geometry will include a tangent condition at the neck anchor boundary, a shoulder in the mid region, and an appropriate stress distributing transition in the wall slope therebetween. The present invention achieves these goals, as will be explained.

### BRIEF SUMMARY OF THE PRESENT INVENTION

The present invention comprises an anchor having an internal passage defined by a revolved wall profile. The anchor is conceptually divided into four regions: a neck region, a transition region, a mid region, and a distal region. Each of these regions has its own design considerations. A portion of an ellipse is used to define at least part of the revolved wall profile. The use of an elliptical portion allows the anchor to be optimized for the different regions.

### BRIEF DESCRIPTION OF THE SEVERAL VIEWS OF THE DRAWINGS

FIG. 1 is a perspective view, showing a prior art termination.

FIG. 2 is a sectioned perspective view, showing internal features of a prior art termination.

FIG. 3 is a sectioned and exploded perspective view, showing internal features of a prior art termination.

FIG. 4 is a sectioned elevation view, showing internal features of a prior art termination.

FIG. 5 is an exploded elevation view, showing the conflicting design constraints for different regions of a termination.

FIG. 6 is a sectioned elevation view, showing a prior art design using a wall profile incorporating a constant radius arc.

FIG. 7 is a sectioned elevation view, showing a prior art design using a wall profile incorporating a portion of a parabola.

FIG. 8 is an exploded elevation view, showing the conflicting design constraints for different regions of a termination.

FIG. 9 is a sectioned elevation view, showing the present invention.

FIG. 9B is an elevation view, showing an ellipse with respect to the origin of a coordinate system.

FIG. 9C is an elevation view, showing an ellipse that has been offset from the origin of a coordinate system.

FIG. 10 is a sectioned elevation view, showing another embodiment of the present invention.

FIG. 11 is sectioned elevation view, showing the use of a combined elliptical and constant radius wall profile.

FIG. 12 is a sectioned elevation view, showing another embodiment of the present invention.

FIG. 13 is a sectioned elevation view, showing another embodiment of the present invention.

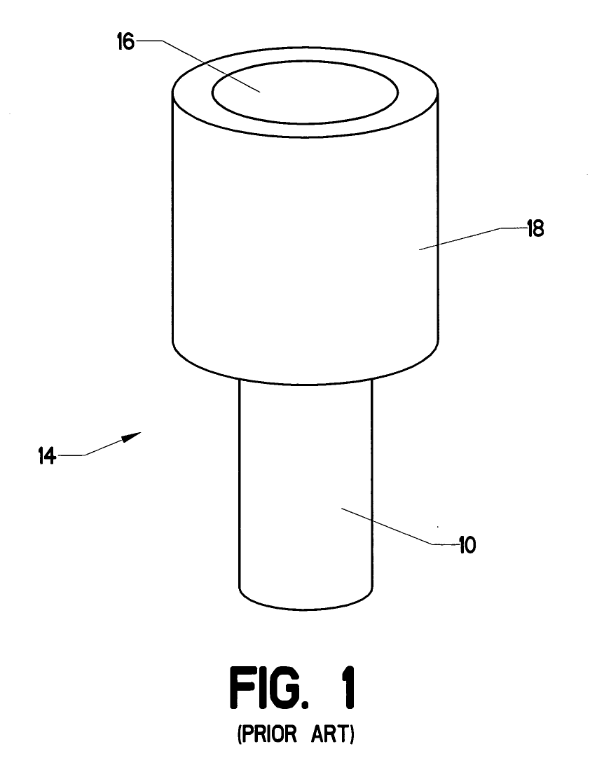

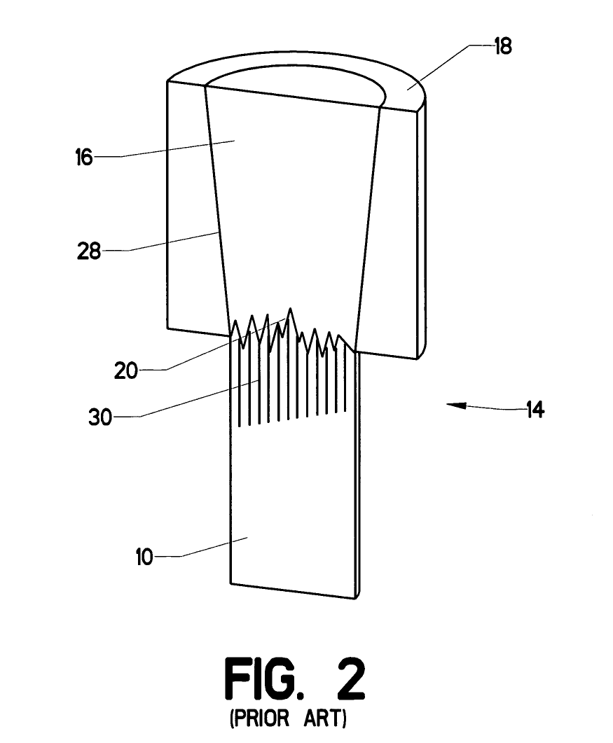

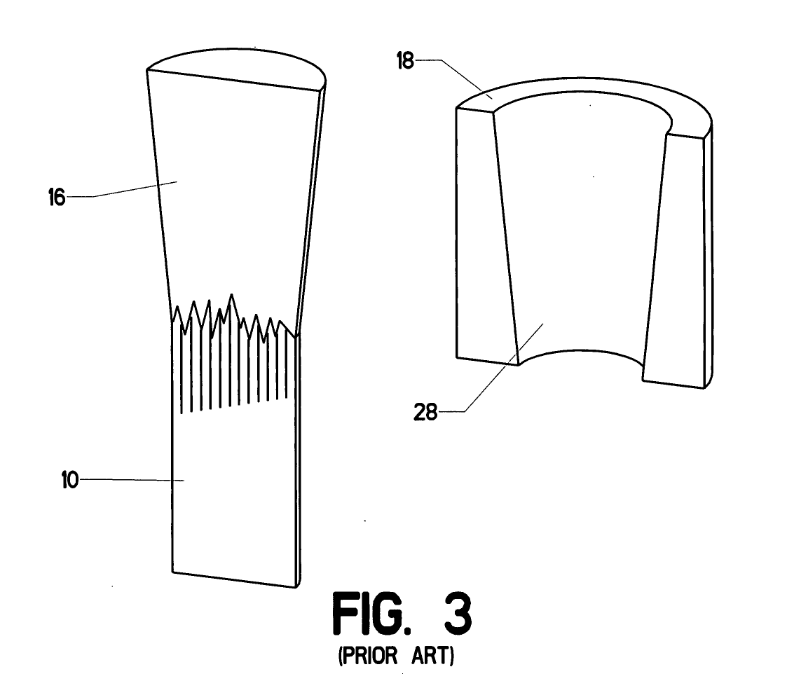

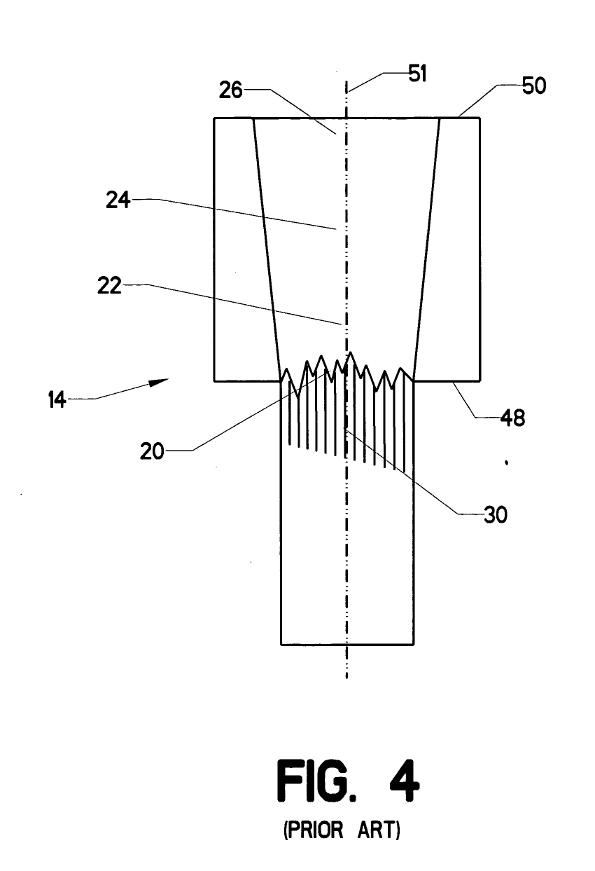

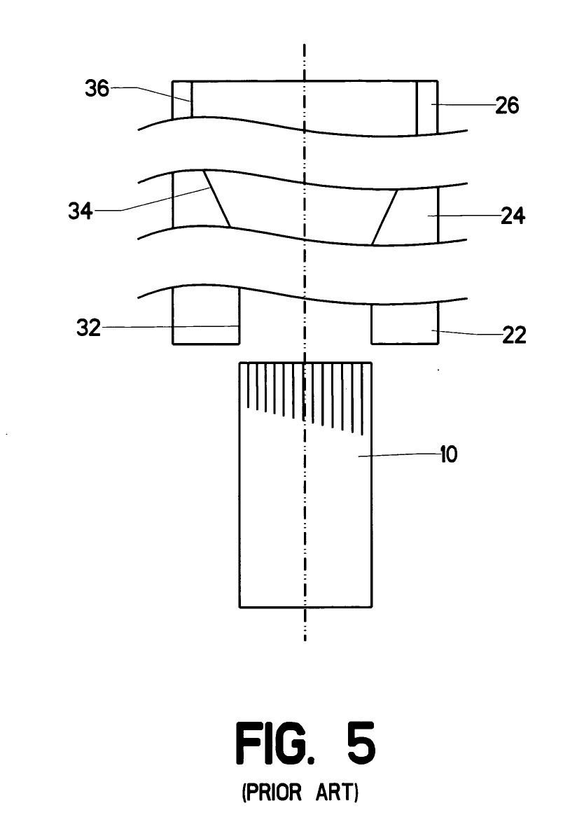

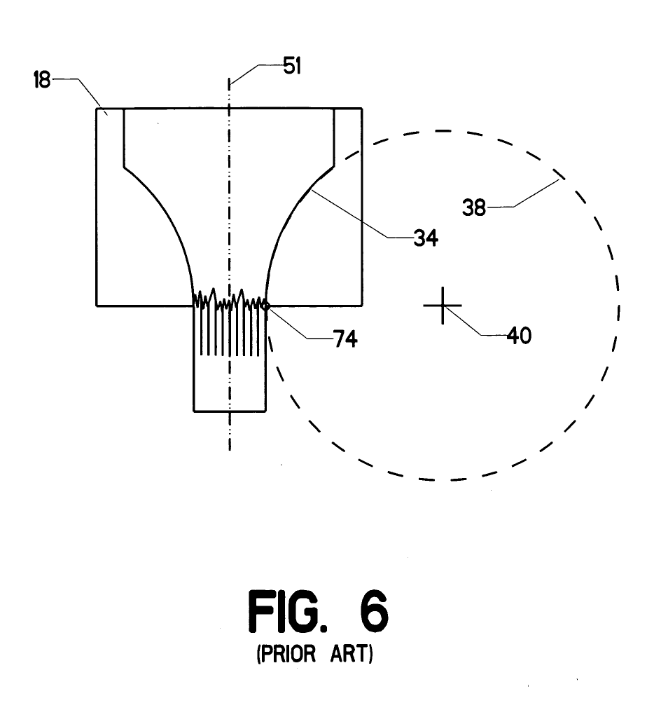

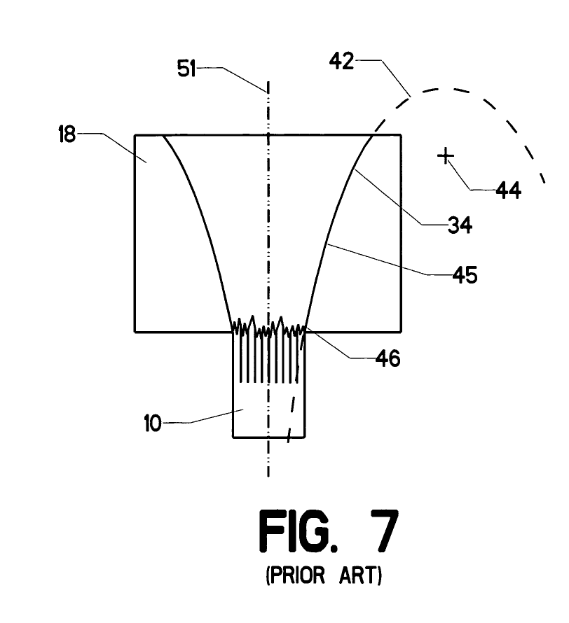

### REFERENCE NUMERALS IN THE DRAWINGS

| | | | |
|---|---|---|---|
| 10 | cable | 14 | termination |
| 16 | potted region | 18 | anchor |
| 20 | potting transition | 22 | neck region |
| 24 | mid region | 26 | distal region |
| 28 | internal passage | 30 | flexible region |
| 32 | tangent wall | 34 | shoulder |
| 36 | extension wall | 38 | constant radius arc |
| 40 | arc center | 42 | parabola |
| 44 | focus | 45 | parabolic wall |
| 46 | non-tangent condition | 48 | neck anchor boundary |
| 50 | distal anchor boundary | 51 | central axis |
| 52 | transition region | 54 | transition wall |
| 56 | ellipse | 58 | ellipse center |
| 60 | major axis | 62 | minor axis |
| 64 | lateral offset | 66 | elliptical wall |
| 67 | gap | 68 | tangent point |
| 70 | longitudinal offset | 72 | straight wall |
| 74 | tangency point | 78 | fillet |
| 80 | load bearing flange | 82 | fillet |
| 84 | curved wall | | |

### DETAILED DESCRIPTION OF THE INVENTION

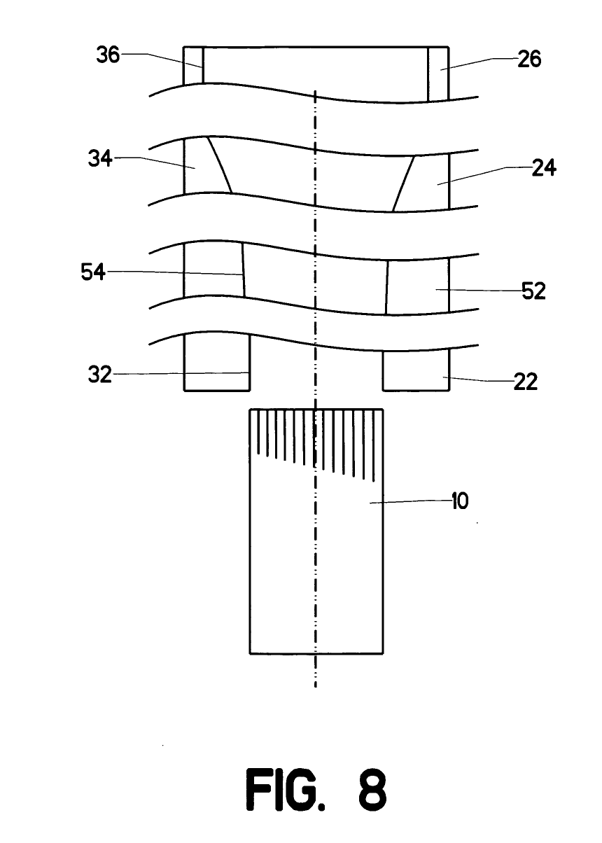

FIG. 8 shows a conceptualized view of an ideal anchor, having a wall profile optimized for each region within the anchor. One of the important concepts in the present invention is the fact that the wall slope must be suitably controlled between a tangent condition at the neck anchor boundary and the shoulder located in the mid region. This goal introduces the concept of a fourth region within the anchor. Thus, the anchor shown in FIG. 8 is divided into four regions: neck region 22, transition region 52, mid region 24, and distal region 26.

In optimizing an anchor, one should consider the wall profiles needed in each of these regions. As previously stated, the wall is preferably tangent to the cable's external diameter within neck region 22. Thus, tangent wall 32 is included. As also previously stated, the inclusion of shoulder 34 within mid region 24 is desirable. Transition region 52 has been identified between neck region 22 and mid region 24, because the inventor has discovered that the wall slope within this transition region is significant to the ultimate breaking strength of the termination. Transition wall 54 is a portion of the profile in which the slope varies in a controlled fashion between the slope of tangent wall 32 and the slope of shoulder 34.

It is preferable to have the wall slope over the neck region, the transition region, and the mid region controlled by a single function, rather than having to employ multiple functions with tangent conditions at the intersections between the functions. There is in fact a single function which achieves these objectives while still providing the necessary control over the wall slope. That function is an ellipse.

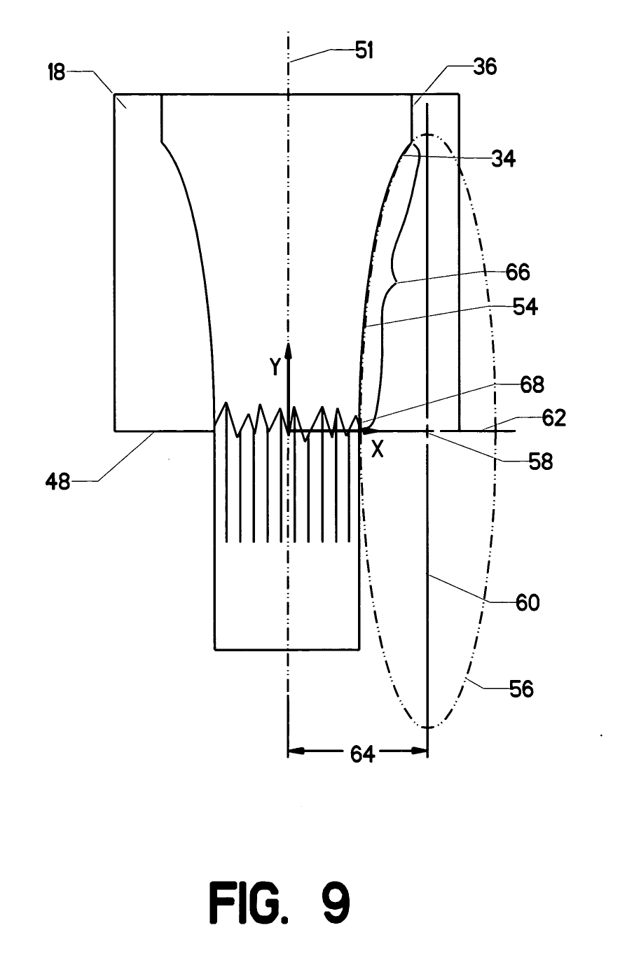

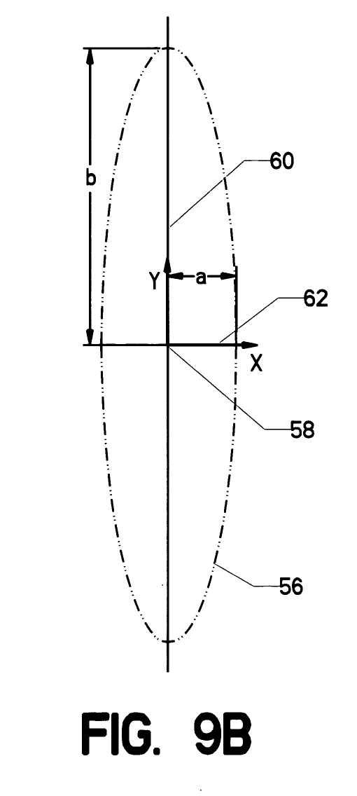

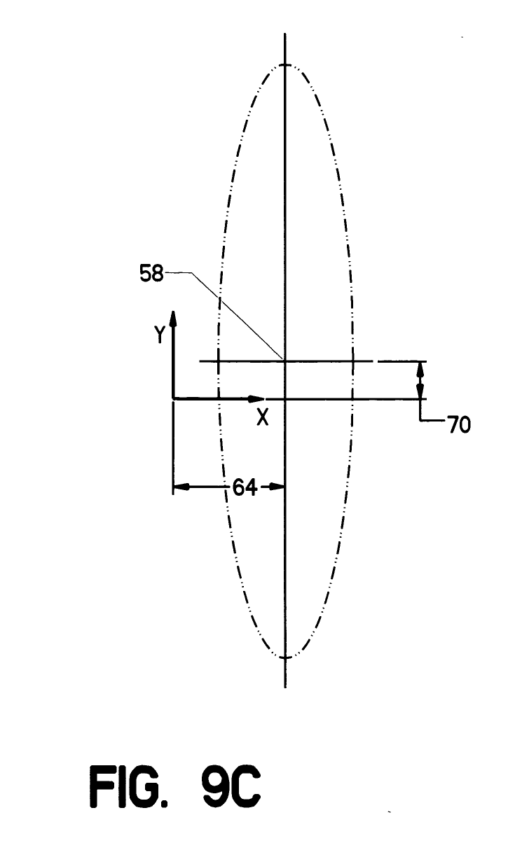

FIG. 9 shows an anchor 18 having a wall profile made according to the present invention. Ellipse 56 is used to define a portion of the wall profile designated as elliptical wall 66. As those skilled in the art will know, ellipse 56 is defined by defining ellipse center 58, major axis 60, and minor axis 62. FIG. 9 also shows an X-Y coordinate system centered on the intersection between central axis 51 and neck anchor boundary 48. This origin can be used to define the mathematics of the ellipse.

FIG. 9B shows an ellipse 56 having ellipse center 58 placed on the origin of the coordinate system. Minor axis 62 extends a length a from either side of the origin along the X axis. Major axis 60 extends a length b up and down from the origin along the Y axis (The reader should bear in mind that the terms “major axis” and “minor axis” are somewhat arbitrary, with the term “major” being used to designate the longer of the two). The ellipse is defined by the expression:

$$\frac{{x}^{2}}{{a}^{2}} + \frac{{y}^{2}}{{b}^{2}} = 1$$

Of course, in order to define the wall profile, the ellipse must be offset from the origin located at the intersection of central axis 51 and neck anchor boundary 48. FIG. 9C graphically depicts these offsets. Ellipse center 58 is offset a distance equal to lateral offset 64 (“Lat.Offset”) along the X Axis. This offset is necessary in order to place elliptical wall 66 in the correct position. FIG. 9C also shows how ellipse center 58 can be offset a distance equal to longitudinal offset 70 (“Long.Offset”) along the Y Axis. This offset is optional, but is advantageous in some circumstances (as will be explained subsequently).

The equation defining the ellipse with the incorporated offsets is written as:

$$\frac{{( x - Lat . Offset )}^{2}}{{a}^{2}} + \frac{{( y - Long . Offset )}^{2}}{{b}^{2}} = 1$$

The radius of the wall profile at any point along the central axis is the variable x in this expression. In order to solve for x, the expression can be rewritten as:

$${( x - Lat . Offset )}^{2} = {a}^{2} \cdot ( 1 - \frac{{( y - Long . Offset )}^{2}}{{b}^{2}}$$

More algebraic manipulation allows this to be rewritten as:

$$x = Lat . Offset \pm \sqrt{{a}^{2} \cdot ( 1 - \frac{{( y - Long . Offset )}^{2}}{{b}^{2}}}$$

The equation gives two values for x for each value of y. With respect to FIG. 9C, the left side of the ellipse is the portion used to define the elliptical wall. Thus, the desired value for x should be written as:

$$x = Lat . Offset - \sqrt{{a}^{2} \cdot ( 1 - \frac{{( y - Long . Offset )}^{2}}{{b}^{2}}}$$

Returning now to the embodiment of FIG. 9, the reader will observe that ellipse 56 includes a lateral offset 64 but no longitudinal offset. The lateral offset and the length of the minor axis are selected so that the elliptical wall profile is tangent to the cable's outer diameter at neck anchor boundary 48 (indicated as tangent point 68). The length of the major axis is selected so that an appropriate shoulder 34 is formed in the anchor's mid region.

Elliptical wall 66 may therefore be conceptually divided into three regions. These are: (1) tangent point 68 proximate neck anchor boundary 48, (2) shoulder 34 in the anchor's mid region, and (3) transition wall 54 between the tangent point and the shoulder. The reader will observe that the single ellipse definition produces the appropriate wall shape in each of these regions.

The elliptical wall can be combined with other known features as well. In FIG. 9, as one example, the elliptical wall is not carried through to the distal anchor boundary. It is instead discontinued in favor of extension wall 36 near the distal anchor boundary. As explained previously, the stress levels proximate the distal anchor boundary are relatively low. Thus, additional expansion of the internal passage is not needed and an extension wall having only a moderate slope (or even no slope or a negative slope) can be used. The intersection between elliptical wall 66 and extension wall 36 is shown as a sharp corner. As the anchor would typically be a machined part, it is preferable to include a fillet at this intersection. The fillet can be large or small, as desired.

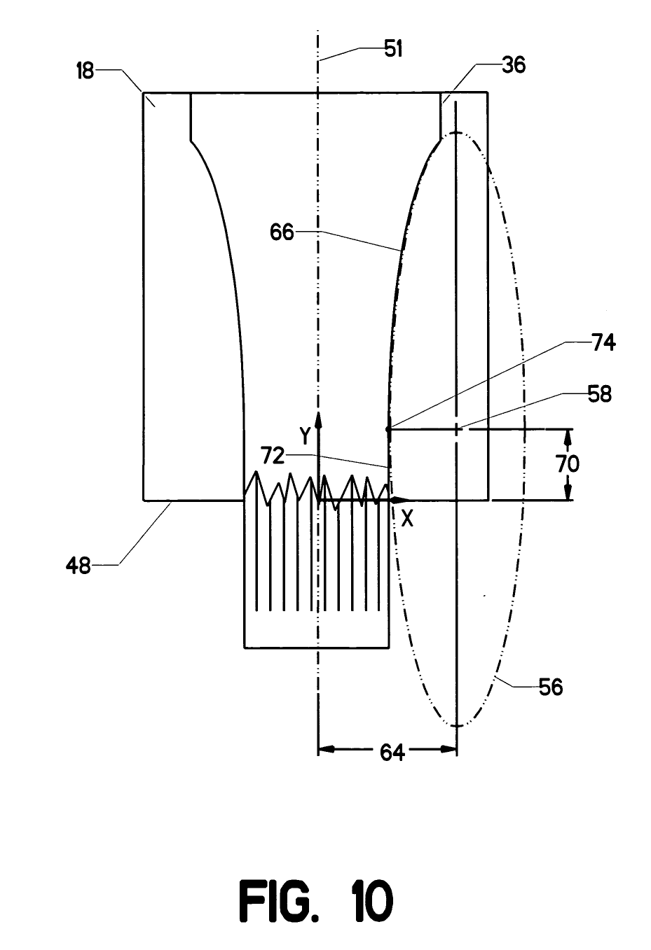

FIG. 10 shows the combination of an elliptical wall with another known wall geometry. Straight wall 72 is used for a portion proximate the neck anchor boundary. Accordingly, ellipse center 58 must be shifted upward (with respect to the orientation shown in the view) a distance equal to longitudinal offset 70. Tangency point 74 lies at the intersection between elliptical wall 66 and straight wall 72. The inclusion of straight wall 72 can provide a more uniform potting transition 20. It is also helpful in some instances to include a length of unpotted strands within the anchor in the region of the neck anchor boundary. Straight wall 72 can be used for this purpose as well.

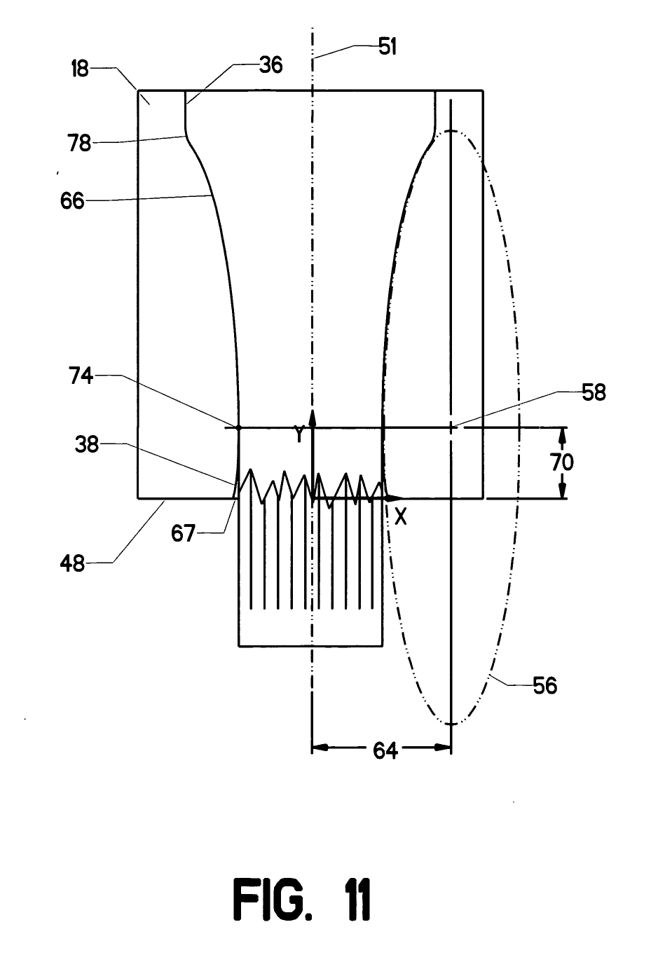

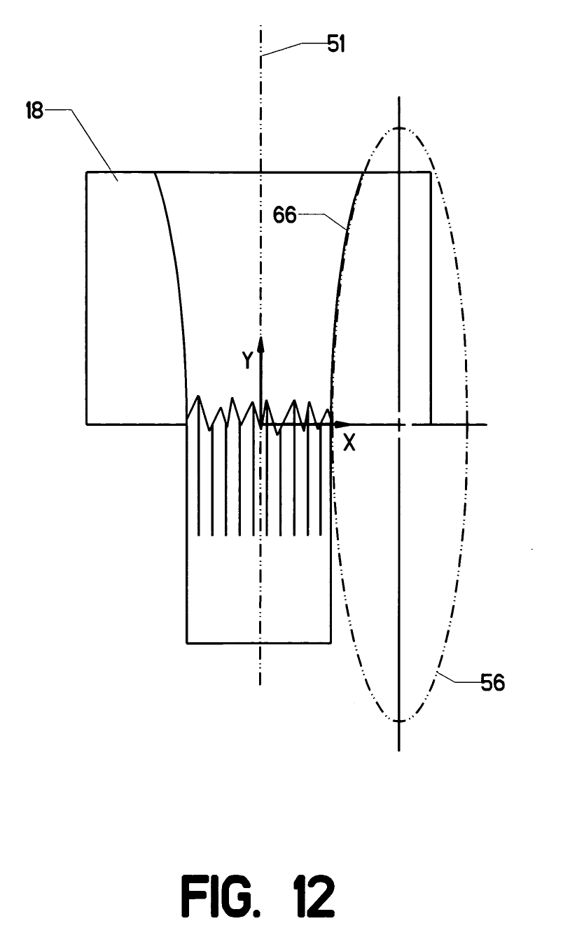

FIG. 11 shows an embodiment in which the elliptical wall profile is combined with a prior art constant radius arc profile. Constant radius arc 38 is located proximate the neck anchor boundary. The arc can be positioned so that a small gap 67 exists between the wall and the cable at the point where the cable exits the anchor (the wall actually bends away from the cable diameter at this point). This gap can be beneficial for instances where the cable flexes laterally with respect to the anchor. The constant radius arc and the elliptical wall are positioned so that tangency point 74 lies at the intersection between the two. This provides a smooth transition between the two types of walls. The reader will note that both a lateral and a longitudinal offset are needed for the ellipse in this case.

The embodiment of FIG. 11 also includes a straight wall 36 near the distal anchor boundary. A fillet 78 is shown between straight wall 36 and elliptical wall 66. The internal passage is typically machined out of a piece of round stock, either on a lathe or automatic screw machine. Thus, it is typical for the size of fillet 78 to be determined by the radius that is present on the cutting tool.

Although it is certainly possible to combine the elliptical wall profile with other shapes, it is also possible to use an elliptical wall profile for the entire internal passage. FIG. 12 shows such an embodiment. Ellipse 56 is used to define an elliptical wall 66. Elliptical wall 66 is present from the neck anchor boundary to the distal anchor boundary. Thus, the reader should understand that the inclusion of a straight wall or any other variation from the elliptical wall in the vicinity of the distal anchor boundary is purely optional. In many embodiments the elliptical wall will simply be carried through to the distal anchor boundary with no other feature being included.

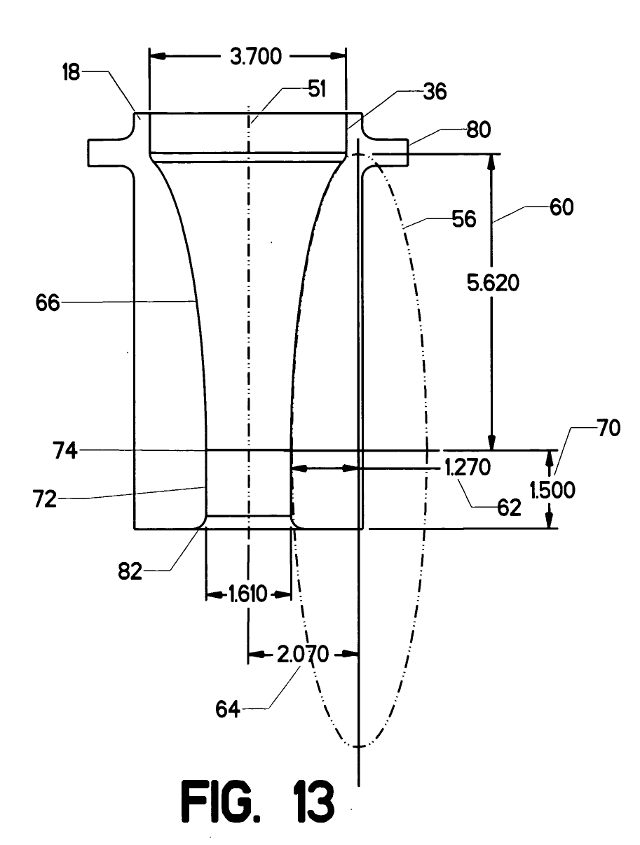

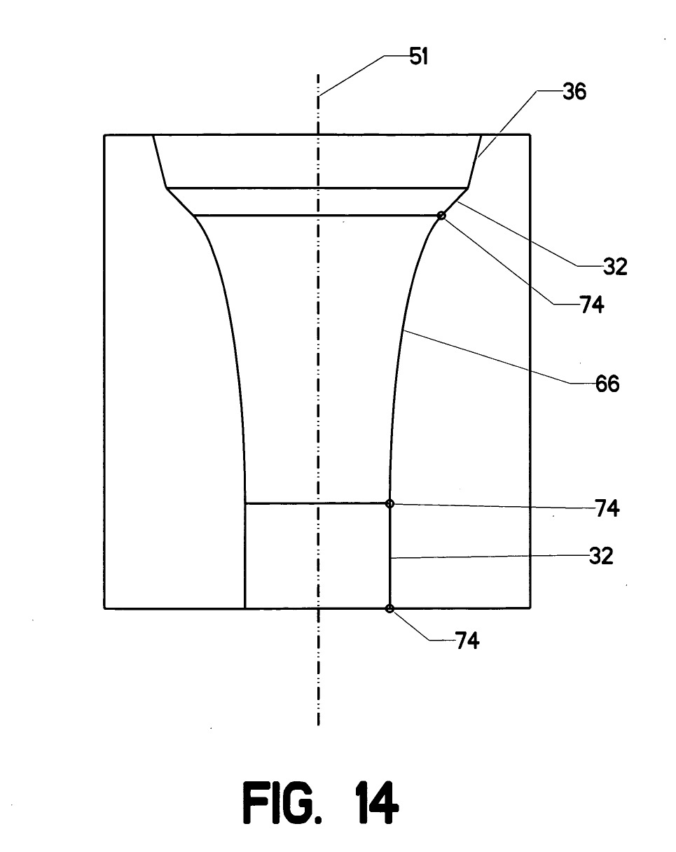

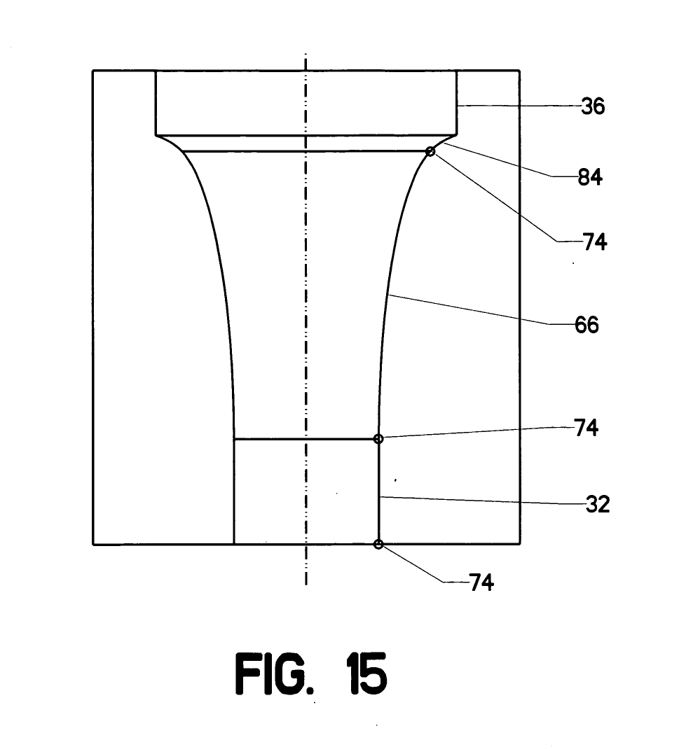

Some dimensioned examples may be helpful to the reader's understanding of the present invention. FIG. 13 is a sectioned elevation view showing one such example. Anchor 18 is designed to be attached to the end of a cable having a diameter of about 1.590 inches (40.4 mm). The distal region of the anchor includes load bearing flange 80. This flange will be used to transmit a tensile load from the cable to an external object.

The portion of the internal passage intersecting the neck anchor boundary is straight wall 72 having a diameter of 1.610 inches (40.9 mm). Fillet 82 is located on the intersection of straight wall 72 and the neck anchor boundary. The straight wall continues toward the distal anchor boundary for a length of 1.500 inches (38.1 mm) (which length becomes longitudinal offset 70 for ellipse 56). Ellipse center 58 is given a lateral offset 64 of 2.070 inches (52.6 mm) and a longitudinal offset 70 of 1.500 inches (38.1 mm). The result is the creation of tangency point 74 between straight wall 72 and elliptical wall 66.

Elliptical wall 66 continues to flare as it proceeds toward the distal anchor boundary. Extension wall 36 is provided proximate the distal anchor boundary itself. The particular extension wall shown defines a cylindrical portion of the internal passage having a diameter of 3.700 inches (94.0 mm). The anchor geometry thus described results in a very high breaking strength for a properly-potted termination.

The elliptical wall profile can be combined with many other known geometries to produce advantages in particular situations. FIG. 14 shows a wall profile in which elliptical wall 66 is combined with a tangent wall 32 (proximate the neck anchor boundary) and a second tangent wall 32 near extension wall 36. The tangent wall proximate the neck anchor boundary provides a smooth transition to the freely flexing portion of the cable. The tangent wall near extension wall 36 extends the length of the shoulder while maintaining the slope of the distal portion of elliptical wall 66.

FIG. 15 shows another embodiment where the distal portion of elliptical wall 66 is joined to curved wall 84. Curved wall 84 can be a constant radius arc, a second order function, or a higher order function. The junction between elliptical wall 66 and curved wall 84 is preferably a tangency point 74. Those skilled in the art will know that perfect tangency is difficult to achieve during machining operations. However, it is preferable to create a junction which is at least close to being tangent and which avoids the presence of a sharp corner. The reader should bear in mind that the creation of a near-tangency will generally be sufficient (true for all the embodiments of this disclosure). Thus, when the term “tangent” is used, the reader should understand this term to encompass approximate tangencies as well.

The various curved walls shown joined to the end of the elliptical portion proximate the distal anchor boundary can also be joined to the end of the elliptical portion proximate the neck anchor boundary. Thus, second order or higher curves could be used in this region as well.

Thus, the reader will appreciate that the use of an elliptical wall profile for at least a portion of the revolved wall defining the internal passage through an anchor produces significant advantages. Those skilled in the art will know that the parameters defining the elliptical wall (such as the values for the major axis, the minor axis, the lateral offset, and the longitudinal offset) can be optimized for each specific application.

Although the preceding description contains significant detail, it should not be construed as limiting the scope of the invention but rather as providing illustrations of the preferred embodiments of the invention. As an example, the wall profile features described in the disclosure could be mixed and combined to form many more permutations than those illustrated. The claims language to follow describes many profiles in terms of precise mathematical functions. Those skilled in the art will know that when actual parts are manufactured, these mathematical functions will be approximated and not recreated exactly. Thus, the language used in the claims is intended to describe the general nature of the wall profiles. It will be understood that physical examples of anchors falling under the claims may deviate somewhat from the precise mathematical equations.

1. An anchor for use in creating a termination on a cable having a diameter, comprising:
a. a neck anchor boundary;
b. a distal anchor boundary;
c. an internal passage between said neck anchor boundary and said distal anchor boundary;
d. wherein said passage is defined by a revolved wall profile; and
e. wherein at least a portion of said wall profile is elliptical.

2. An anchor as recited in claim 1, wherein:
a. said elliptical wall begins proximate said neck anchor boundary; and
b. at the beginning of said elliptical wall, the diameter of said internal passage is approximately equal to said diameter of said cable.

3. An anchor as recited in claim 2, wherein said revolved wall profile further comprises a straight wall lying between said neck anchor boundary and said beginning of said elliptical wall, wherein said straight wall is tangent to said elliptical wall at said beginning of said elliptical wall.

4. An anchor as recited in claim 1, wherein:
a. said elliptical wall has a beginning and an end; and
b. said end of said elliptical wall lies proximate said distal anchor boundary.

5. An anchor as recited in claim 4, wherein said revolved wall profile further comprises an extension wall lying between said end of said elliptical wall and said distal anchor boundary.

6. An anchor as recited in claim 5, wherein said extension wall and said end of said elliptical wall are joined by a fillet.

7. An anchor as recited in claim 1, wherein said revolved wall profile further comprises a straight wall lying between said neck anchor boundary and said beginning of said elliptical wall, wherein said straight wall is tangent to said elliptical wall at said beginning of said elliptical wall.

8. An anchor as recited in claim 7, wherein:
a. said elliptical wall has a beginning and an end; and
b. said end of said elliptical wall lies proximate said distal anchor boundary.

9. An anchor as recited in claim 8, wherein said revolved wall profile further comprises an extension wall lying between said end of said elliptical wall and said distal anchor boundary.

10. An anchor as recited in claim 9, wherein said extension wall and said end of said elliptical wall are joined by a fillet.

11. An anchor as recited in claim 1, wherein said revolved wall profile further comprises a constant radius arc lying between said neck anchor boundary and said elliptical wall.

12. An anchor as recited in claim 1, wherein said revolved wall profile further comprises a parabolic wall lying between said neck anchor boundary and said elliptical wall.

13. An anchor for use in creating a termination on a cable having a diameter, comprising:
a. a neck anchor boundary;
b. a distal anchor boundary;
c. an internal passage between said neck anchor boundary and said distal anchor boundary;
d. wherein said passage is defined by a revolved wall profile revolved around a central axis;
e. a coordinate system having an origin on the intersection between said neck anchor boundary and said central axis, wherein said coordinate system includes an x axis extending perpendicularly to said central axis and ay axis extending along said central axis;
f. wherein the variable x is defined as the radius of said revolved wall profile at any distance y along said y axis;
g. wherein at least a portion of said wall profile is defined by an ellipse having a center, an axis in the x direction equal to two times a, and an axis in they direction equal to two times b.
h. wherein said center of said ellipse is offset a distance Lat.Offset in the x direction from said origin and a distance Long.Offset in they direction from said origin; and
g. wherein said elliptical portion of said revolved wall profile is defined by the expression
$$x = Lat . Offset = \sqrt{{a}^{2} \cdot ( 1 - \frac{{( y - Long . Offset )}^{2}}{{b}^{2}}} .$$

14. An anchor as recited in claim 13, wherein the value for said Long.Offset is zero.

15. An anchor as recited in claim 13, wherein:
a. said elliptical portion of said revolved wall profile begins proximate said neck anchor boundary; and
b. at the beginning of said elliptical portion of said revolved wall profile, the diameter of said internal passage is approximately equal to said diameter of said cable.

16. An anchor as recited in claim 15, further comprising a straight wall portion lying between said neck anchor boundary and said beginning of said elliptical portion of said revolved wall profile elliptical wall profile.

17. An anchor as recited in claim 13, wherein:
a. said elliptical portion of said revolved wall profile has a beginning and an end; and
b. said end of said elliptical portion of said revolved wall profile lies proximate said distal anchor boundary.

18. An anchor as recited in claim 17, further comprising a straight wall portion lying between said end of said elliptical wall profile and said distal anchor boundary.

19. An anchor as recited in claim 18, wherein said straight wall portion and said end of said elliptical portion of said revolved wall profile are joined by a fillet.

20. An anchor as recited in claim 17, further comprising a first straight wall portion lying between said neck anchor boundary and said beginning of said elliptical portion of said revolved wall profile, wherein said first straight wall portion is tangent to said elliptical portion of said revolved wall profile at said beginning of said elliptical portion of said revolved wall profile.

21. An anchor as recited in claim 20, further comprising a second straight wall portion lying between said end of said elliptical portion of said revolved wall profile and said distal anchor boundary.

22. An anchor as recited in claim 2, wherein:
a. said elliptical wall has a beginning and an end;
b. said end of said elliptical wall lies proximate said distal anchor boundary; and
c. said revolved wall profile further comprises a tangent wall lying between said end of said elliptical wall and said distal anchor boundary, with said tangent wall being tangent to said end of said elliptical wall.

23. An anchor as recited in claim 2, wherein:
a. said elliptical wall has a beginning and an end;
b. said end of said elliptical wall lies proximate said distal anchor boundary; and
c. said revolved wall profile further comprises a curved wall lying between said end of said elliptical wall and said distal anchor boundary, with said curved wall being tangent to said end of said elliptical wall.

24. An anchor as recited in claim 1, wherein said revolved wall profile further comprises a curved wall lying between said neck anchor boundary and said elliptical wall.
